(19) United States
(12) Patent Application Publication
(10) Pub. No.: US 2025/0279676 A1
(43) Pub. Date: Sep. 4, 2025

(54) TOPOLOGY OPTIMIZATION DESIGN METHOD AND APPARATUS FOR TRANSMITTER FERRITE AND RECEIVER COIL FOR LIGHTWEIGHTING OF WIRELESS CHARGING DEVICE

(71) Applicant: Korea Advanced Institute of Science and Technology, Daejeon (KR)

(72) Inventor: Changwoo LEE, Daejeon (KR)

(73) Assignee: Korea Advanced Institute of Science and Technology, Daejeon (KR)

(21) Appl. No.: 18/947,875

(22) Filed: Nov. 14, 2024

(30) Foreign Application Priority Data
Mar. 4, 2024 (KR) 10-2024-0030899

(51) Int. Cl. H02J 50/00

(52) U.S. Cl. CPC H02J 50/005

(57) ABSTRACT

Disclosed are a topology optimization design method and apparatus for transmitter ferrite and a receiver coil for the lightweighting of a wireless charging device. The topology optimization design method and apparatus may be configured to express at least some area in which a charging component is to be disposed in a wireless charging device as a plurality of finite elements, calculate a derived voltage of the at least some area through an analysis of the plurality of finite elements, and derive a topology optimization design for a structure of the charging component within the at least some area by performing optimization based on the derived voltage.

### CROSS-REFERENCE TO RELATED APPLICATION

This application is based on and claims priority under 35 U.S.C. 119 to Korean Patent Application No. 10-2024-0030899, filed on Mar. 4, 2024, in the Korean intellectual property office, the disclosures of which are herein incorporated by reference in their entireties.

### TECHNICAL FIELD

The present disclosure relates to a topology optimization design method and apparatus for transmitter ferrite and a receiver coil for the lightweighting of a wireless charging device.

### BACKGROUND OF THE DISCLOSURE

Recently, the wireless charging technology is widely used. Today, the wireless charging technology is applied to the smartphone device field, and the commercialization of the application of the wireless charging technology to an electric vehicle field is also Furthermore, the wireless charging technology may be extended and in progress. applied to robot, urban air mobility (UAM), space, and aviation fields.

In general, a wireless charging device includes a transmitter and a receiver. The transmitter includes at least one transmitter coil for power transmission and at least one piece of ferrite for increasing power transmission efficiency. However, the ferrite becomes a factor to increase the weight of the transmitter. If the transmitter includes multiple pieces of ferrite, the weight of the transmitter is further increased. The reason for this is that an optimized design of the ferrite for minimizing the weight of the transmitter is impossible because the design of the transmitter is performed depending on a designer's intuition. The receiver includes at least one receiver coil for power reception. In this case, the receiver may also use ferrite for improving power reception efficiency, but does not user ferrite due to a weight increase. However, the receiver coil becomes a factor to increase the weight of the receiver. If the receiver includes multiple receiver coils, the weight of the receiver is further increased. The reason for this is that an optimized design of the receiver coils for minimizing the weight of the receiver is impossible because the design of the receiver is performed depending on a designer's intuition.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Embodiments of the present disclosure provide a topology optimization design method and apparatus for transmitter ferrite and a receiver coil for the lightweighting of a wireless charging device.

In an embodiment, there is provided a method of a computer device, which performs a topology optimization design on a wireless charging device. The method may include expressing at least some area in which a charging component is to be disposed in a wireless charging device as a plurality of finite elements, calculating a derived voltage of the at least some area through the analysis of the plurality of finite elements, and deriving a topology optimization design for the structure of the charging component within the at least some area by performing optimization based on the derived voltage.

In an embodiment, there is provided a computer device which performs a topology optimization design on a wireless charging device. The computer device may include memory and a processor connected to the memory and configured to execute at least one instruction that is stored in the memory. The processor is configured to express at least some area in which a charging component is to be disposed in a wireless charging device as a plurality of finite elements, calculate a derived voltage of the at least some area through the analysis of the plurality of finite elements, and derive a topology optimization design for the structure of the charging component within the at least some area by performing optimization based on the derived voltage.

In an embodiment, there is provided a non-transitory computer-readable recording medium in which a computer program for executing a method of performing a topology optimization design on a wireless charging device in a computer device. The method may include expressing at least some area in which a charging component is to be disposed in a wireless charging device as a plurality of finite elements, calculating a derived voltage of the at least some area through the analysis of the plurality of finite elements, and deriving a topology optimization design for the structure of the charging component within the at least some area by performing optimization based on the derived voltage.

According to the present disclosure, a topology optimization design for the structure of a charging component within a wireless charging device can be performed based on an algorithm that is designed in software without depending on a designer's intuition. In particular, a topology optimization design for the structure of a charging component within a wireless charging device can be performed so that weight can be minimized while satisfying a target voltage. This can maximize use efficiency of the wireless charging device. As a result, the present disclosure can significantly reduce time and costs that are necessary for a design, fabrication, and experiments by making unnecessary the fabrication of multiple unit products and repeated experiments for each unit product.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a diagram schematically illustrating a computer device according to various embodiments.

FIGS. 2A and 2B are diagrams for describing a topology optimization design for a charging component of the computer device in FIG. 1.

FIG. 3 is a diagram schematically illustrating an operating method of the computer device according to various embodiments.

FIGS. 4A and 4B are diagrams for exemplarily describing the operating method of FIG. 3.

FIG. 5 is a diagram specifically illustrating a step of expressing at least some area as finite elements in FIG. 3.

FIG. 6 is a diagram specifically illustrating a step of calculating a derived voltage in FIG. 3.

FIG. 7 is a diagram specifically illustrating a step of deriving a topology optimization design in FIG. 3.

FIGS. 8, 9A, 9B, 9C, and 9D are diagrams for describing a topology optimization design that is performed on a case in which a transmitter includes two transmitter coils (Case 1) according to a first method (Case 1-1).

FIG. 10 is a diagram illustrating the results of a topology optimization design for ferrite, which is performed on the case in which the transmitter includes two transmitter coils according to a first method (Case 1-1).

FIG. 11 is a diagram for describing a topology optimization design that is performed on a case in which the transmitter includes two transmitter coils according to a third method (Case 1-3).

FIG. 12 is a diagram illustrating the results of a topology optimization design for a receiver coil, which is performed on the case in which a transmitter includes two transmitter coils according to the three methods.

(a) of FIG. 13 is a diagram illustrating a distribution of magnetic fields in ferrite that has been optimized according to the first method, and (b) of FIG. 13 is a diagram illustrating a distribution of magnetic fields in a ferrite plate according to the third method. FIG. 14 is a diagram illustrating the results (i.e., a distribution of magnetic fields) of the analysis of finite elements according to the three methods.

FIGS. 15, 16A, 16B, 16C, and 16D are diagrams for describing a topology optimization design that is performed on the case in which a transmitter includes four transmitter coils according to the first method.

FIG. 17 is a diagram illustrating the results of a topology optimization design for ferrite, which is performed on the case in which a transmitter includes four transmitter coils according to the first method.

FIG. 18 is a diagram illustrating the results of a topology optimization design for a receiver coil, which is performed on the case in which a transmitter includes two transmitter coils according to the three methods.

FIG. 19 is a diagram illustrating the results (i.e., a distribution of magnetic fields) of the analysis of finite elements according to the three methods.

### DETAILED DESCRIPTION

While illustrative embodiments have been illustrated and described, it will be appreciated that various changes can be made therein without departing from the spirit and scope of the disclosure.

Hereinafter, various embodiments of the present disclosure are described with reference to the accompanying drawings.

Hereinafter, embodiments of the present disclosure provide a computer device that performs a topology optimization design on a wireless charging device and an operating method of the computer device. Specifically, in an embodiment of the present disclosure, the computer device can perform a topology optimization design on the structure of a charging component within a wireless charging device so that weight can be minimized while satisfying a target voltage.

Hereinafter, a wireless charging device indicates an electronic device for wireless charging, and may include at least one of a transmitter or a receiver. A charging component indicates a component related to wireless charging within a wireless charging device, and may include at least one piece of ferrite of a transmitter or at least one of one or more receiver coils of a receiver. The structure of the charging component may include at least one of the number of charging components, or a shape (e.g., circular, angular, or curvature), dimension (e.g., a width, a length, and a height), or location of the charging component. If the charging component is a receiver coil, the structure of the charging component may further include the number of turns of the receiver coil.

In general, a transmitter may include at least one transmitter coil and at least one piece of ferrite, and a receiver may include at least one receiver coil. At least one air layer that hinders leakage flux in a radiation direction is present in a plane that is horizontal to the cross sectional area of a transmitter coil. In order to improve a coupling coefficient between the transmitter coil and the receiver coil, ferrite may be implemented to surround a corresponding air layer. In this case, the ferrite may include an inner part within the cross sectional area of the transmitter coil in the plane and an outskirt part that surrounds the air layer in the plane. The inner part may be connected to the outskirt part. For example, the ferrite may have a W-shaped form or a T-shaped form on the basis of the plane that is vertical to the cross sectional area of the transmitter coil.

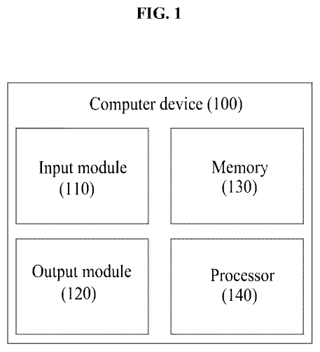

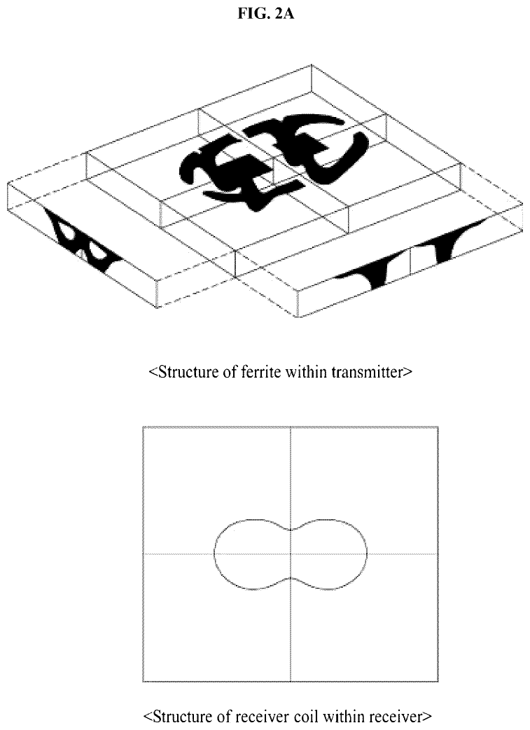

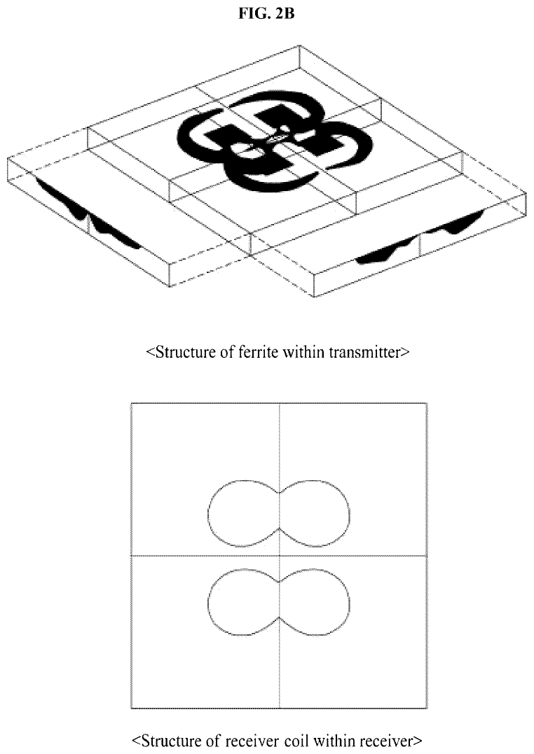

FIG. 1 is a diagram schematically illustrating a computer device 100 according to various embodiments. FIGS. 2A and 2B are diagrams for describing a topology optimization design for a charging component of the computer device 100 in FIG. 1.

Referring to FIG. 1, the computer device 100 is provided to perform a topology optimization design on at least one charging component within at least one wireless charging device, and includes at least one of an input module 110, an output module 120, memory 130, or a processor 140. In an embodiment, at least one of the components of the computer device 100 may be omitted, and at least another component is added to the computer device 100. In an embodiment, at least two of the components of the computer device 100 are implemented as one integrated circuit.

The input module 110 inputs a signal to be used in at least one component of the computer device 100. The input module 110 includes at least one of an input device configured so that a user directly inputs a signal to the computer device 100, a sensor device configured to generate a signal by detecting a surrounding change, or a reception device configured to receive a signal from an external device. For example, the input device includes at least one of a microphone, a mouse, or a keyboard. In an embodiment, the input device includes at least one of touch circuitry configured to detect a touch or a sensor circuit configured to measure the intensity of a force that is generated by a touch.

The output module 120 outputs information to the outside of the computer device 100. The output module 120 includes at least one of a display device configured to visually output information, an audio output device capable of outputting information as audio signal, or a transmission device capable of wirelessly transmitting information. For example, the display device includes at least one of a display, a hologram device, or a projector. For example, the display device is implemented as a touch screen by being assembled with at least one of the touch circuitry or sensor circuit of the input module 110. For example, the audio output device includes at least one of a speaker or a receiver.

According to an embodiment, the reception device and the transmission device are implemented with a communication module. The communication module performs communication with an external device in the computer device 100. The communication module establishes a communication channel between the computer device 100 and the external device, and performs communication with the external device through the communication channel. In this case, the external device includes at least one of a vehicle, a satellite, a base station, a server or another computer system. The communication module includes at least one of a wired communication module or a wireless communication module. The wired communication module is connected to the external device in a wired way, and communicates with the external device in a wired way. The wireless communication module includes at least one of a short-distance communication module or a long-distance communication module. The short-distance communication module communicates with the external device using the short-distance communication method. For example, the short-distance communication method includes at least one of Bluetooth, WiFi direct, or infrared data association (IrDA). The long-distance communication module communicates with the external device using the long-distance communication method. In this case, the long-distance communication module communicates with the external device over a network. For example, the network includes at least one of a cellular network, the Internet, or a computer network, such as a local area network (LAN) or a wide area network (WAN).

The memory 130 stores various data used by at least one component of the computer device 100. For example, the memory 130 includes at least one of a volatile memory or a nonvolatile memory. The data includes at least one program and input data or output data related thereto. The program is stored in the memory 130 as software including at least one instruction, and includes at least one of an operating system, middleware, or an application.

The processor 140 controls at least one of the components of the computer device 100 by executing a program of the memory 130. Accordingly, the processor 140 performs data processing or an operation. In this case, the processor 140 executes an instruction stored in the memory 130.

In various embodiments, the processor 140 may perform a topology optimization design on the structure of a charging component within a wireless charging device so that weight can be minimized while satisfying a target voltage. The wireless charging device indicates an electronic device for wireless charging, and may include at least one of a transmitter or a receiver. The charging component indicates a component related to wireless charging within the wireless charging device, and may include at least one piece of ferrite of a transmitter or at least one of one or more receiver coils of a receiver. For example, as illustrated in FIG. 2A, the processor 140 may derive a topology optimization design for at least one of the structure of ferrite within a transmitter or the structure of a receiver coil within a receiver with respect to a case in which the transmitter includes two transmitter coils. As another example, as illustrated in FIG. 2B, the processor 140 may derive a topology optimization design for at least one of the structure of ferrite within a transmitter or the structure of a receiver coil within a receiver with respect to a case in which the transmitter includes four transmitter coils. The structure of the ferrite may include at least one of the number of pieces of ferrite or a shape (e.g., circular, angular, or curvature), dimension (e.g., a width, a length, and a height), or location of the ferrite. The structure of the receiver coil may include at least one of the number of receiver coils, a shape (e.g., circular, angular, or curvature), dimension (e.g., a width, a length, and a height), or location of the receiver coil, or the number of turns of the receiver coil.

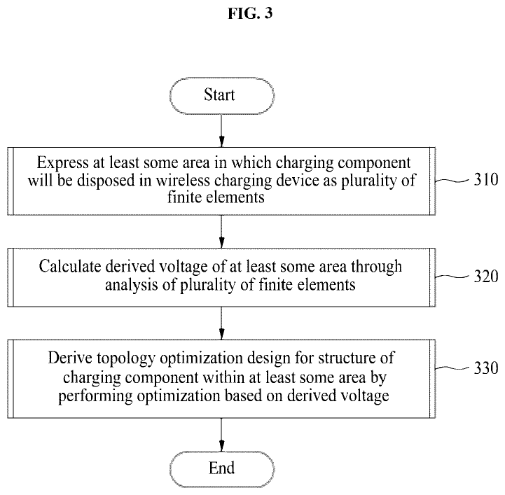

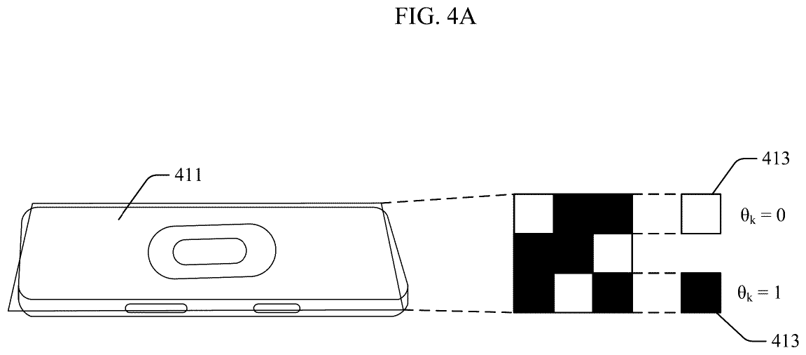

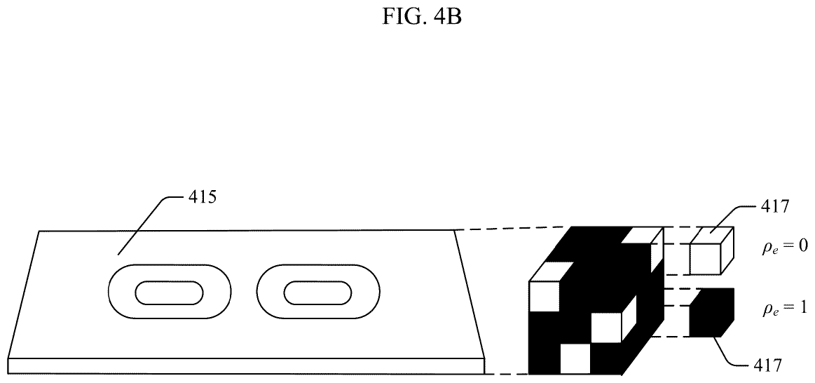

FIG. 3 is a diagram schematically illustrating an operating method of the computer device 100 according to various embodiments. FIG. 4 is a diagram for exemplarily describing the operating method of FIG. 3.

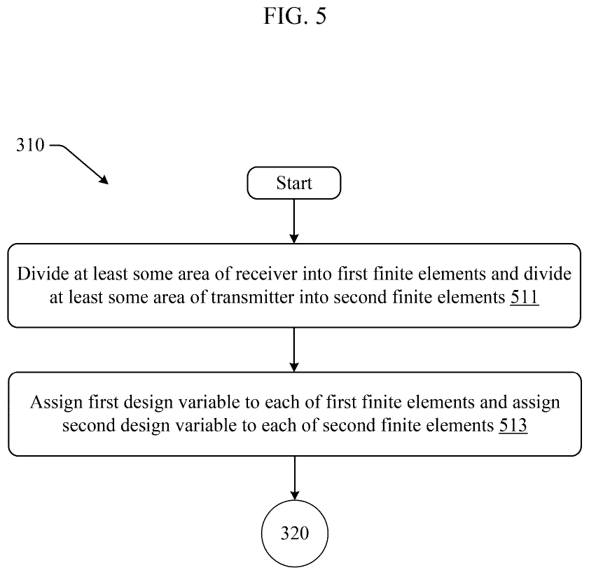

Referring to FIG. 3, in step 310, the computer device 100 may express at least some area 411, 415 in which a charging component will be disposed in a wireless charging device as a plurality of finite elements 413, 417. Specifically, the reception area 411 in which at least one receiver coil will be disposed in a receiver may be defined. Accordingly, as illustrated in FIG. 4A, the processor 140 may express the reception area 411 as a plurality of first finite elements 413. The transmission area 415 in which at least one piece of ferrite will be disposed in a transmitter may be defined. In this case, at least one transmitter coil will also be disposed in the transmission area 415 in addition to the ferrite because the at least one transmitter coil is disposed within the ferrite in the transmitter. Accordingly, as illustrated in FIG. 4B, the processor 140 may express the transmission area 415 as a plurality of second finite elements 417. This will be described more specifically with reference to FIG. 5.

FIG. 5 is a diagram specifically illustrating the step (step 310) of expressing the at least some areas as the plurality of finite elements 413, 417 in FIG. 3.

Referring to FIG. 5, in step 511, the processor 140 may divide the at least some area 411, 415 in which a charging component will be disposed as the plurality of finite elements 413, 417. Specifically, the reception area 411 in which at least one reception coil will be disposed in the receiver may be defined. Accordingly, as illustrated in FIG. 4A, the processor 140 may divide the reception area 411 as the plurality of first finite elements 413. For example, the reception area 411 may be divided into about 26,533 first finite elements 413. The transmission area 415 in which at least one piece of ferrite will be disposed in the transmitter may be defined. In this case, the at least one transmitter coil will also be disposed in the transmission area 415 in addition to the ferrite because the at least one transmitter coil is disposed within the ferrite in the transmitter. Accordingly, as illustrated in FIG. 4B, the processor 140 may divide the transmission area 415 as the plurality of second finite elements 417. For example, the transmission area 415 may be divided into about 66,558 second finite elements 417.

Next, in step 513, the processor 140 may assign a design variable (θₖ, ρₑ) to each of the finite element 413 and 417. The design variable (θₖ, ρₑ) may be defined to express multiple material states. In this case, the material states relate to the material of the charging component and the air. The design variable (θₖ, ρₑ) may be for indicating the relative density of the material of the charging component. Specifically, in order to express the material (e.g., copper) of the receiver coil and the air, the processor 140 may assign the first design variable (θₖ) indicative of the relative density of the receiver coil to each of the plurality of first finite elements 413 of the reception area 411. For example, when the relative density of a k-th first finite element 413 is 1 (θₓ=1) in the reception area 411, this may mean that the k-th first finite element 413 belongs to the receiver coil. When the relative density of the k-th first finite element 413 is 0 (θₖ=0) in the reception area 411, this may mean that the k-th first finite element 413 belongs to the air. Accordingly, a design variable set may be constructed (θ=[θ₁, . . . , θₖₘₐₓ]^{T}) with respect to the reception area 411. In order to express the material (e.g., Mn—Zn) of the ferrite and the air, the processor 140 may assign a second design variable (ρₑ) indicative of the relative density of the ferrite to each of the plurality of second finite elements 417 of the transmission area 415. For example, when the relative density of an e-th second finite element 417 is 1 (ρₑ=1) in the transmission area 415, this may mean that the e-th second finite element 417 belongs to the ferrite. When the relative density of the e-th second finite element 417 is 0 (ρₑ=0) in the transmission area 415, this may mean that the e-th second finite element 417 belongs to the air. Accordingly, a design variable set may be constructed (ρ=[ρ₁, . . . , ρₑₘₐₓ]^{T}) with respect to the transmission area 415. Thereafter, the processor 140 returns to FIG. 3, and may proceed to step 320.

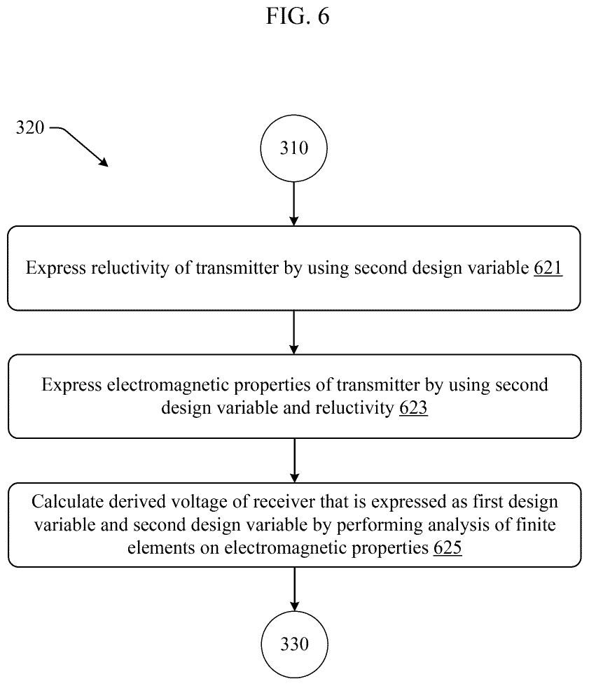

Referring back to FIG. 3, in step 320, the computer device 100 may calculate a derived voltage of the at least some area 411, 415 in which the charging component will be disposed through the analysis of the plurality of finite elements. Specifically, the processor 140 may express the derived voltage of the at least some area 411, 415 in which the charging component will be disposed, by using at least one of the first design variable (θₖ) or the second design variable (ρₑ). This will be described more specifically with reference to FIG. 6.

FIG. 6 is a diagram specifically illustrating the step (step 320) of calculating the derived voltage in FIG. 3.

Referring to FIG. 6, in step 621, the processor 140 may express reluctivity of the transmitter by using the second design variable (ρₑ). In this case, the processor 140 may express the reluctivity of each of the plurality of second finite elements 417 of the transmission area 415 by using the second design variable (ρₑ) of the transmission area 415. In this case, the reluctivity may be expressed like Equation 1.

$${v}_{e}^{( RAMP )} ( {ρ}_{e} ) = {v}^{( air )} + ( {v}^{( iron )} - {v}^{( air )} ) ( \frac{{ρ}_{e}}{1 + q ( 1 - {ρ}_{e} )} ) \qquad ( 1 )$$

$$,$$

$$\{ \begin{matrix}{v}_{e} ( 0 ) = {v}^{( air )} + = {v}^{( air )} & ( if {ρ}_{e} = 0 ) \\ {v}_{e} ( 1 ) = + ( {v}^{( iron )} - ) {\underbrace{( \frac{{ρ}_{e}}{1 + q ( 1 - {ρ}_{e} )} )}}_{1} = {v}^{( iron )} & ( if {ρ}_{e} = 1 )\end{matrix}$$

In Equation 1, a subscript “e” may indicate the index of each finite element 417 in the transmission area 415. vₑ^{(RAMP)} may indicate the reluctivity of the e-th second finite element 417. ρₑ is the second design variable (0≤ρₑ≤1) indicative of the relative density of the e-th second finite element 417. q may indicate a penalization parameter for expressing the ferrite. v^{(iron)} may indicate the reluctivity of the ferrite. v^{(air)} may indicate the reluctivity of the air.

Next, in step 623, the processor 140 may express electromagnetic properties of the transmitter by using the second design variable (ρₑ) and the reluctivity. That is, the processor 140 may express the electromagnetic properties of each of the plurality of second finite elements 417 of the transmission area 415 by using the second design variable (ρₑ) and reluctivity of the transmission area 415. In this case, the electromagnetic properties, for example, electric field intensity may be expressed as Maxwell's equation, such as Equation 2.

$${H}_{e} = {v}_{e}^{( RAMP )} ( {ρ}_{e} ) {B}_{e} \qquad ( 2 )$$

In Equation 2, bold refers to a vector. He may indicate the electric field intensity (unit: A/m) of the e-th second finite element 417. Bₑ may indicate the magnetic flux density (unit: T) of the e-th second finite element 417.

Next, in step 625, the processor 140 may calculate the derived voltage of the receiver by performing the analysis of the plurality of finite elements on the electromagnetic properties of the transmitter. That is, the processor 140 may derive the solution of Equation 2 by performing the analysis of the plurality of finite elements on the electromagnetic properties of each of the plurality of second finite elements 417 of the transmission area 415. In this case, the derived voltage of each of the plurality of first finite elements 413 of the reception area 411 is calculated like Equation 3. This may indicate an inductive counter voltage that is induced into the receiver coil, specifically, when the number of turns of the receiver coil is 1 turn. Accordingly, Equation 3 may be expressed from the design variable sets (ρ=[ρ₁, . . . , ρₑₘₐₓ]^{T} and θ=[θ₁, . . . , θₖₘₐₓ]^{T}) of the transmission area 415 and the reception area 411. That is, the derived voltage may be expressed as the first design variable (θₖ) and the second design variable (ρₑ). When the waveform of the derived voltage is a sine wave or a cosine wave, the Equation 3 may be expressed like Equation 4. Accordingly, in the reception area 411, a total counter electromotive voltage that is induced into the receiver coil may be expressed like Equation 5. Thereafter, the processor 140 returns to FIG. 3, and may proceed to step 330.

$${V}_{k} ( ρ , {θ}_{k} , t ) = - {( {θ}_{k} )}^{p} \frac{d {\int }_{{S}_{k}} {μ}_{0} H ( ρ , t ) \cdot {dS}_{k}}{dt} \qquad ( 3 )$$

In Equation 3, a subscript “k” may indicate the index of each first finite element 413 in the reception area 411. Vₖ may indicate the derived voltage of the k-th first finite element 413. p may indicate a penalization parameter for expressing the receiver coil. μ₀ may indicate the permeability of the air. H (t) may indicate a time-varying magnetic field intensity. Sₖ may indicate a vector that is vertical to the cross sectional area of the k-th first finite element 413. θₖ may be the first design variable (0≤θₖ≤1) indicative of the relative density of the k-th first finite element 413.

$${V}_{k} ( ρ , {θ}_{k} ) = - {( {θ}_{k} )}^{p} ω {\int }_{{S}_{k}} B ( ρ ) \cdot {dS}_{k}$$

$$,$$

$$\{ \begin{matrix}{V}_{k} ( ρ , 0 ) = - ω {\int }_{{S}_{k}} B ( ρ ) \cdot {dS}_{k} & ( if {θ}_{k} = 0 ) \\ {V}_{k} ( ρ , 1 ) = - ω {\int }_{{S}_{k}} B ( ρ ) \cdot {dS}_{k} & ( if {θ}_{k} = 1 )\end{matrix} \qquad ( 4 )$$

$${V}_{total} ( ρ , θ ) = - {\sum }_{k = 1}^{{k}_{max}} ( {( {θ}_{k} )}^{p} ω {\int }_{{S}_{k}} B ( ρ ) \cdot {dS}_{k} ) \qquad ( 5 )$$

Referring back to FIG. 3, in step 330, the computer device 100 may derive a topology optimization design for the structure of the charging component within the at least some area 411, 415 in which the charging component will be disposed, by performing optimization based on the derived voltage. Specifically, the processor 140 may perform a topology optimization design on the structure of at least one charging component within at least one wireless charging device so that weight can be minimized while satisfying a target voltage. This will be described more specifically with reference to FIG. 6.

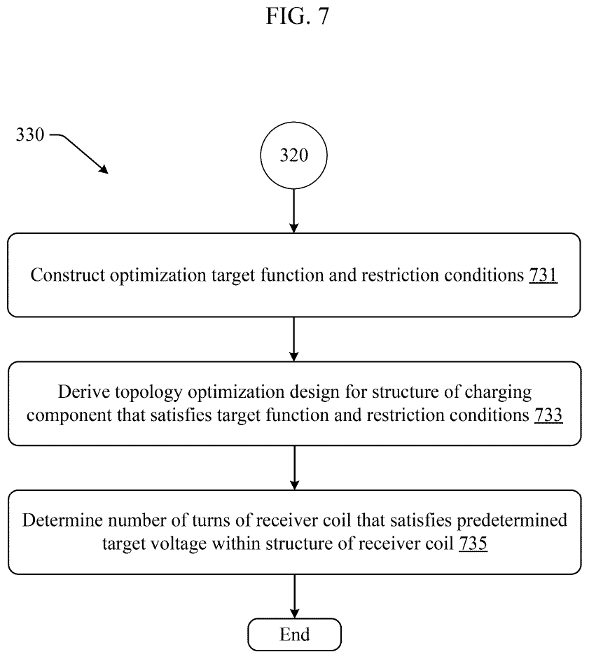

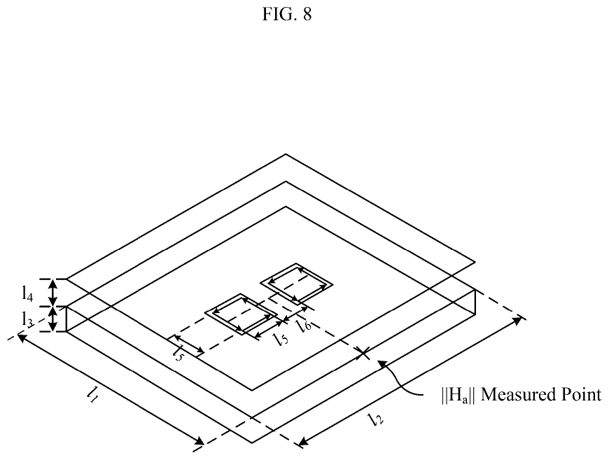

FIG. 7 is a diagram specifically illustrating the step (step 330) of deriving the topology optimization design in FIG. 3.

Referring to FIG. 7, in step 731, the processor 140 may construct an optimization target function and restriction conditions. The target function may be set as the maximization of a derived voltage. Furthermore, the restriction conditions may be set as at least one of a condition in which the weight of a charging component is a preset weight or less (i.e., weight restriction conditions) or a condition in which magnetic intensity measured at an arbitrary point in order to satisfy the International Standards for Human Hazard is a preset value or less (i.e., magnetic intensity the restriction conditions). Accordingly, the processor 140 may generate an optimization problem based on the target function and the restriction conditions. In this case, the optimization problem may be generated like Equation 6.

$$Find [ ρ ; θ ] \qquad ( 6 )$$

$$to maxmize f ( ρ , θ ) = \frac{{V}_{total} ( ρ , θ )}{{f}^{*}}$$

$$subject to {g}_{1} ( ρ ) = \frac{{M}^{( iron )} ( ρ )}{{M}^{*}} - 1 \leq 0$$

$${g}_{2} ( ρ ) = \frac{‖ {H}_{a} ( ρ ) ‖}{{H}_{a}^{*}} - 1 \leq 0$$

$$θ = {[ {θ}_{1} , … , {θ}_{kmax} ]}^{T}$$

$$ρ = {[ {ρ}_{1} , … , {ρ}_{emax} ]}^{T}$$

$${ρ}^{min} \leq {ρ}_{e} \leq {ρ}^{max} , for e = 1 , … , {e}_{max}$$

$${θ}^{min} \leq {θ}_{k} \leq {θ}^{max} , for k = 1 , … , {k}_{max}$$

In Equation 6, M^{(iron)}(ρ) may indicate at least one weight of a charging component, for example, the ferrite of a transmitter or the receiver coil of a receiver. M* may indicate a preset value for a comparison with the weight of the charging component. Hₐ may indicate magnetic intensity that is measured at an arbitrary point. Hₐ* may indicate a preset value for a comparison with the measured magnetic intensity.

Next, in step 733, the processor 140 may derive a topology optimization design for the structure of a charging component that satisfies the target function and the restriction conditions. Specifically, the processor 140 may derive the topology optimization design for the structure of the charging component by solving the optimization problem based on the target function and the restriction conditions. Accordingly, the topology optimization design for the structure of the charging component, for example, at least one of the ferrite of the transmitter or the receiver coil of the receiver can be derived so that weight can be minimized while satisfying a target voltage. The structure of the ferrite may include at least one of the number of pieces of ferrite or a shape (e.g., circular, angular, or curvature), dimension (e.g., a width, a length, and a height), or location of the ferrite. The structure of the receiver coil may include at least one of the number of receiver coils or a shape (e.g., circular, angular, or curvature), dimension (e.g., a width, a length, and a height), or location of the receiver coil.

Next, in step 735, the processor 140 may determine the number of turns of the receiver coil that satisfies a predetermined target voltage within the structure of the receiver. In this case, the number of turns may be determined like Equation 7.

$$N = \frac{V *}{V ( {ρ}^{( optimized )} , {θ}^{( optimized )} )} \qquad ( 7 )$$

In Equation 7, V* may indicate the target voltage. N may indicate the number of turns of the receiver coil. V (ρ^{(optimized)}, θ^{(optimized)}) may indicate a maximum derived voltage of the receiver coil per turn, which is calculated through Equation 6.

As described above, the computer device 100 may perform a topology optimization design on the structure of a charging component within a wireless charging device so that weight can be minimized while satisfying a target voltage. Specifically, the processor 140 may perform a topology optimization design on at least one of the ferrite of a transmitter or the receiver coil of a receiver according to three methods. A first method is to optimize the structure of the ferrite of the transmitter along with the structure of the receiver coil of the receiver. A second method is to optimize the structure of the receiver coil of the receiver by fixing the entire transmission area 415 to the air. A third method is to optimize the receiver coil of the receiver by fixing the entire transmission area 415 to a ferrite plate.

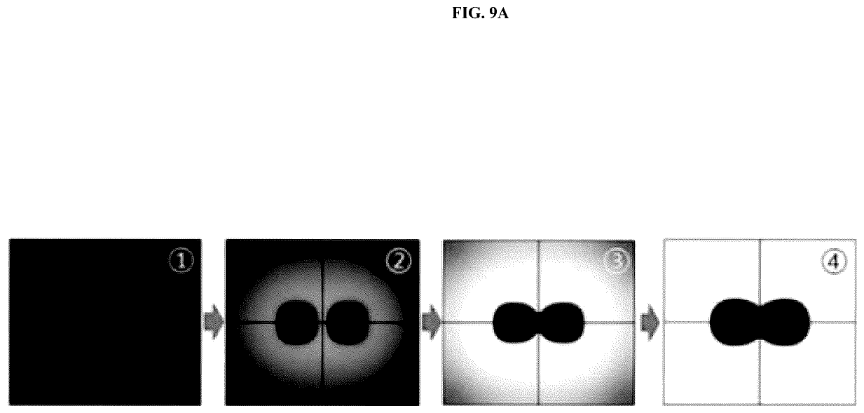

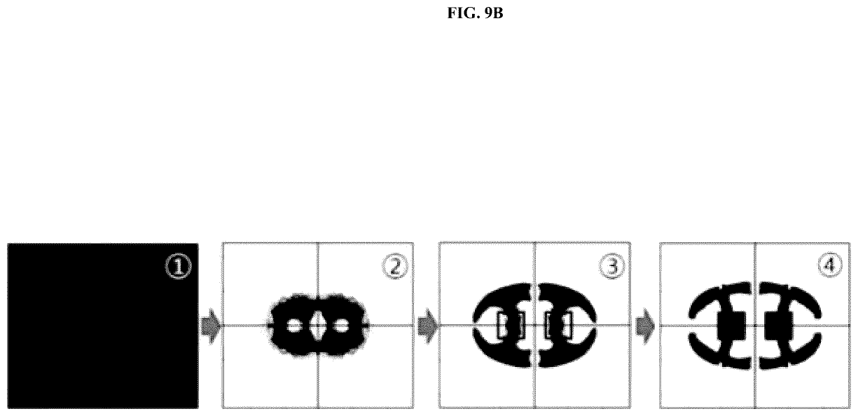

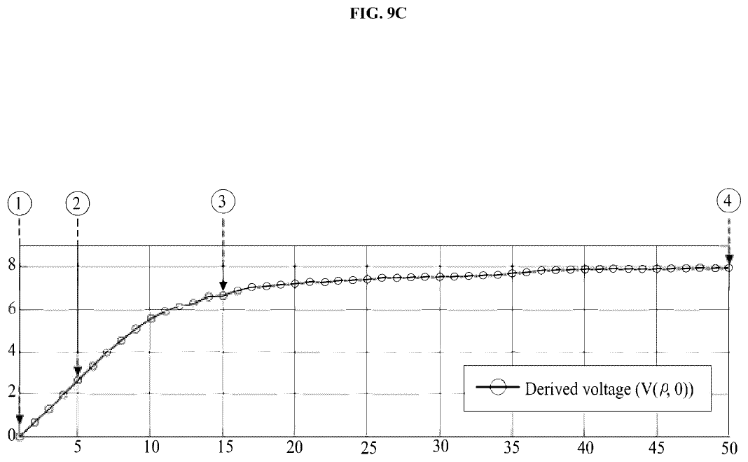

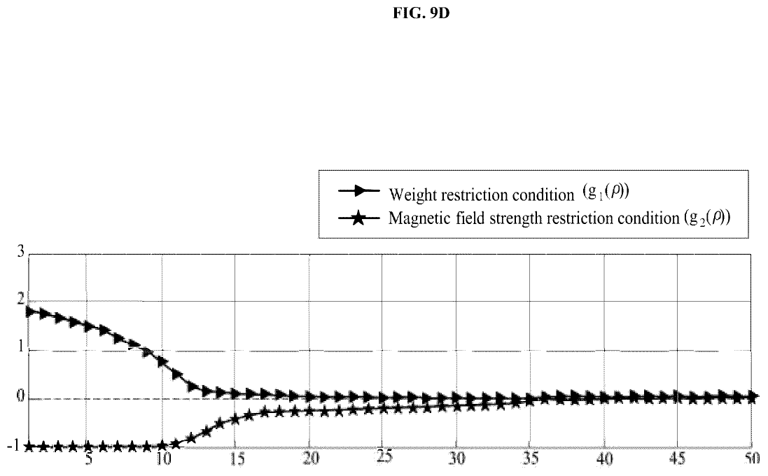

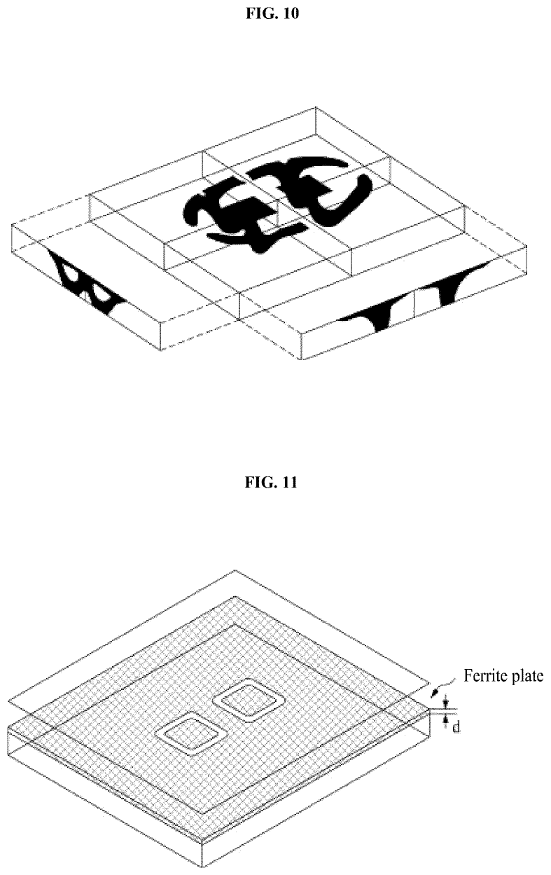

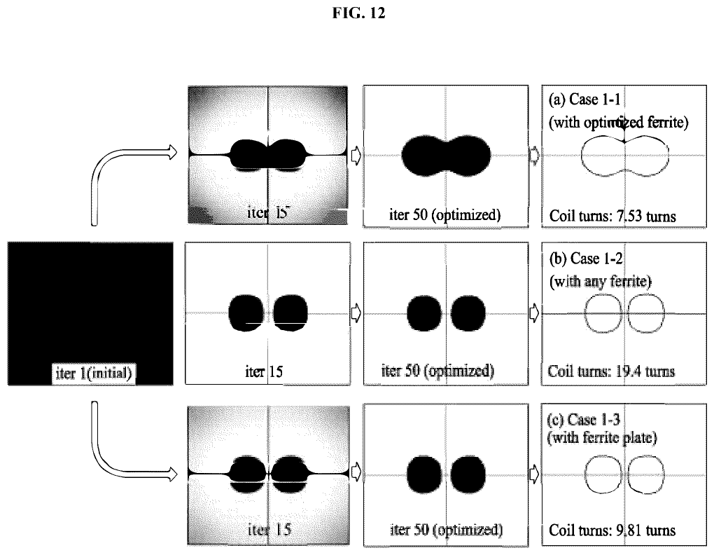

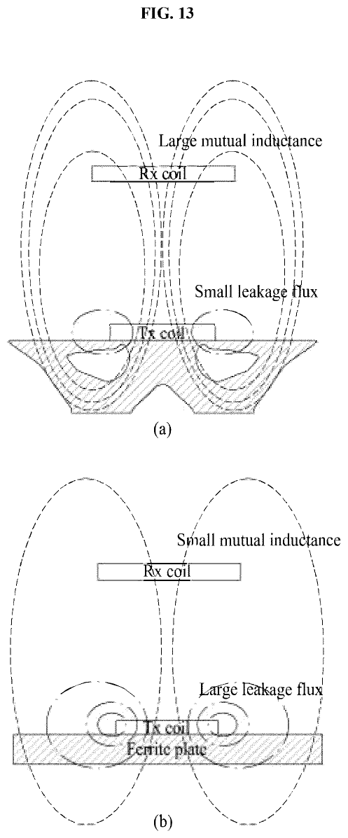

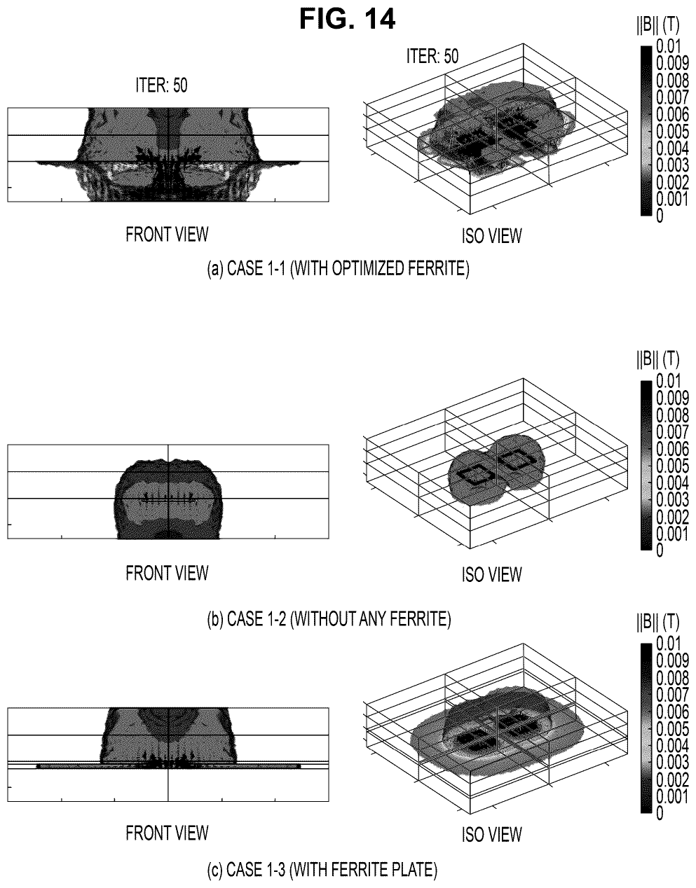

FIGS. 8, 9A, 9B, 9C, and 9D are diagrams for describing a topology optimization design that is performed on a case in which a transmitter includes two transmitter coils (Case 1) according to the first method (Case 1-1). FIG. 10 is a diagram illustrating the results of a topology optimization design for ferrite, which is performed on the case in which the transmitter includes two transmitter coils (Case 1) according to the first method (Case 1-1). FIG. 11 is a diagram for describing a topology optimization design that is performed on the case in which the transmitter includes two transmitter coils (Case 1) according to the third method (Case 1-3). FIG. 12 is a diagram illustrating the results of a topology optimization design for a receiver coil, which is performed on the case in which the transmitter includes two transmitter coils (Case 1) according to the three methods (Case 1-1, Case 1-2, and Case 1-3). (a) of FIG. 13 is a diagram illustrating a distribution of magnetic fields in ferrite that has been optimized according to the first method (Case 1-1), and (b) of FIG. 13 is a diagram illustrating a distribution of magnetic fields in a ferrite plate according to the third method (Case 1-3). FIG. 14 is a diagram illustrating the results (i.e., a distribution of magnetic fields) of the analysis of finite elements according to the three methods (Case 1-1, Case 1-2, and Case 1-3).

In the first method (Case 1-1), as illustrated in FIG. 8, the transmitter has two transmitter coils, and a reception area and a transmission area are defined. According to the first method, in the reception area and the transmission area, the structure of a receiver coil and the structure of ferrite are optimized. Specifically, the structure of the receiver coil is gradually optimized in the reception area according to optimization iteration as illustrated in FIG. 9A. The structure of the ferrite is gradually optimized in the transmission area according to optimization iteration as illustrated in FIG. 9B. In this case, a target function is maximized according to the optimization iteration as illustrated in FIG. 9C. All of the restriction conditions have converged less than 0 according to the optimization iteration as illustrated in FIG. 9D, which means that the restriction conditions have been satisfied.

As a result, as illustrated in FIG. 10, the structure of the ferrite is obtained. In a plane that is horizontal to the cross sectional area of a transmitter coil, at least one air layer that hinders leakage flux in a radiation direction thereof is present. In order to increase a coupling coefficient between the transmitter coil and the receiver coil, the ferrite is implemented to surround the at least one air layer. In this case, the ferrite includes an inner part within the cross sectional area of the transmitter coil in the plane and an outskirt part that surrounds the air layer in the plane. The inner part is connected to the outskirt part. For example, the ferrite may have a W-shaped form or a T-shaped form on the basis of a plane that is vertical to the cross sectional area of the transmitter coil.

Furthermore, in the second method (Case 1-2), although not illustrated, the transmitter has two transmitter coils, and a reception area and a transmission area are defined. In this case, the entire transmission area is fixed to the air, and the transmitter coil of the receiver is optimized. In the third method (Case 1-3), as illustrated in FIG. 11, the transmitter has two transmitter coils, and a reception area and a transmission area are defined. In this case, the entire transmission area is fixed to the ferrite plate, and the receiver coil of the receiver is optimized.

As illustrated in FIG. 12, the results of the topology optimization designs for the receiver coil which are performed according to the three methods (Case 1-1, Case 1-2, and Case 1-3) are changed according to the optimization iteration. According to the first method (Case 1-1), the final structure of the receiver coil has an 8-shaped form as a single coil. According to the second and third methods (Case 1-2 and Case 1-3), the final structure of the receiver coil includes two separated coils, and each coil has an elliptical shape. In order to satisfy a target voltage, the numbers of turns of the receiver coil in the first, second, and third methods (Case 1-1, Case 1-2, and Case 1-3) are 7.53 turns, 19.4 turns, and 9.81 turns, respectively. That is, all of the structures of the receiver coils that are derived according to the three methods (Case 1-1, Case 1-2, and Case 1-3) satisfy the target voltage (e.g., 5 V). In this case, for a fair comparison, the weights of the ferrite in the first method and third method (Case 1-1 and Case 1-3) were identically set, and the electric field strength restriction conditions were satisfied. The results of FIG. 12 are arranged like Table 1.

TABLE 1

| | First method | | | | Third method | |
|---|---|---|---|---|---|---|
| | (Case 1-1; | | Second method | | (Case 1-3; | |
| | including optimized | | (Case 1-2; | | including ferrite | |
| | ferrite) | | No ferrite) | | plate) | |
| Target | 5.00 V | | | | | |
| voltage | | | | | | |
| Available | 125 g | | | | | |
| ferrite | | | | | | |
| weight | | | | | | |
| Reference | 5.00 A/m | | | | | |
| electric field | | | | | | |
| strength | | | | | | |
| Derived | 5.00 | V | 5.00 | V | 5.00 | V |
| voltage | | | | | | |
| Ferrite | 125 | g | 0 | | 125 | g |
| weight | | | | | | |
| Electric | 3.50 | A/m | 1.76 | A/m | 7.66 | A/m |
| field strength | | | | | | |
| Number of | 7.53 | turns/sets | 19.4 | turns/sets | 9.81 | turns/sets |
| turns of | | | | | | |
| receiver coil | | | | | | |
| Number of | 1 | set | 2 | sets | 2 | sets |
| receiver | | | | | | |
| coil sets | | | | | | |
| Receiver | 0.623 | g | 1.69 | g | 0.882 | g |
| coil weight | | | | | | |

| | | | |
|---|---|---|---|
| Receiver coil | −63.1% | 0.00% | −47.8% |
| weight ratio | | | |

According to Table 1, the third method can more reduce the weight of the receiver coil by about 47.8% than the second method. The first method can more reduce the weight of the receiver coil by about 63.1% than the second method. The reason why the first method can more reduce the weight of the receiver coil than the third method may be described by comparing (a) and (b) of FIG. 13. As illustrated in (a) of FIG. 13, the optimized ferrite has small leakage flux because the optimized ferrite has the air layer that hinders leakage flux. Accordingly, more magnetic flux may be generated from the transmitter to the receiver. That is, a coupling coefficient between the transmitter coil of the transmitter and the receiver coil of the receiver may be increased. In contrast, as illustrated in (b) of FIG. 13, the ferrite plate has great leakage flux because the ferrite plate does not include the air layer that hinders leakage flux. Accordingly, magnetic flux that is generated by the transmitter is not transmitted to the receiver. This may be checked through the results (i.e., a distribution of magnetic fields) of the analysis of the plurality of finite elements illustrated in FIG. 14.

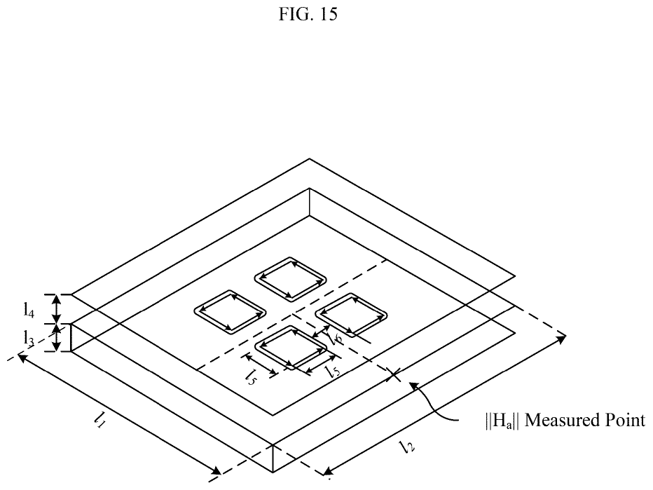

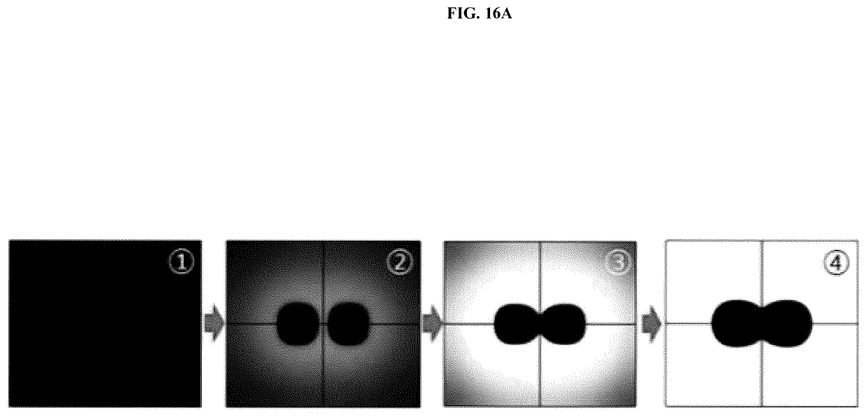

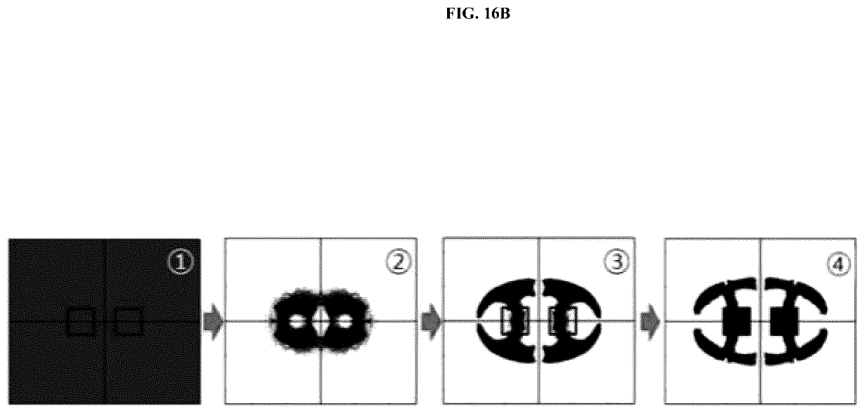

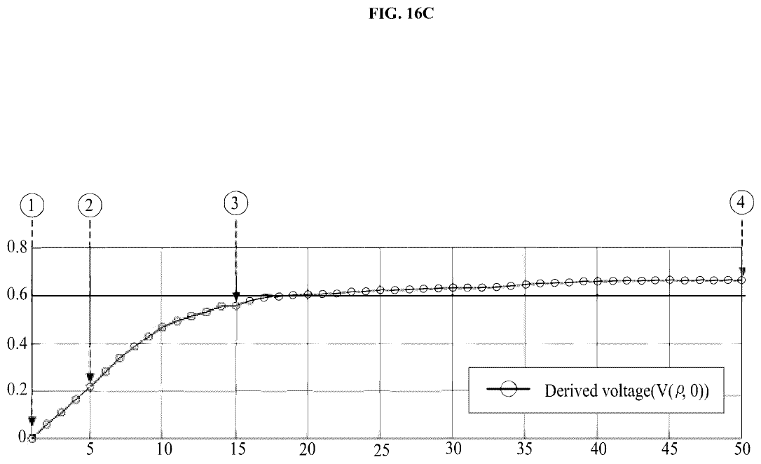

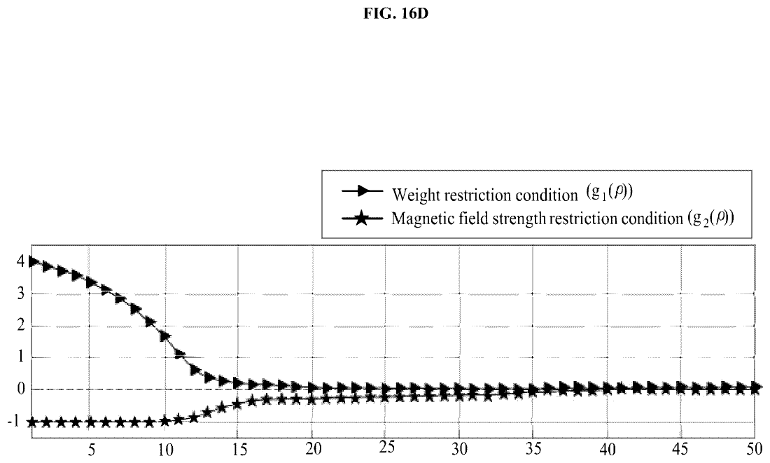

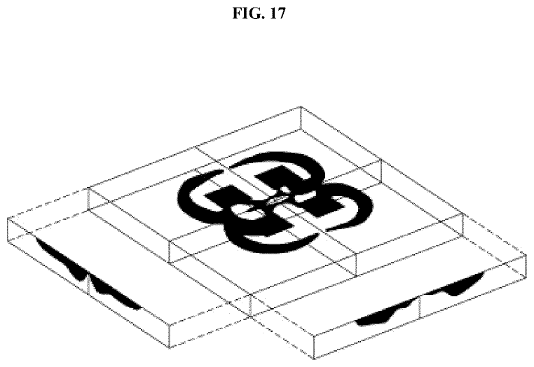

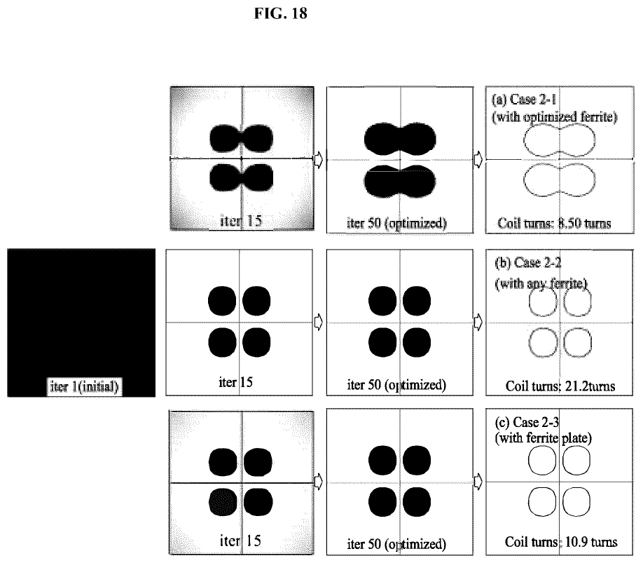

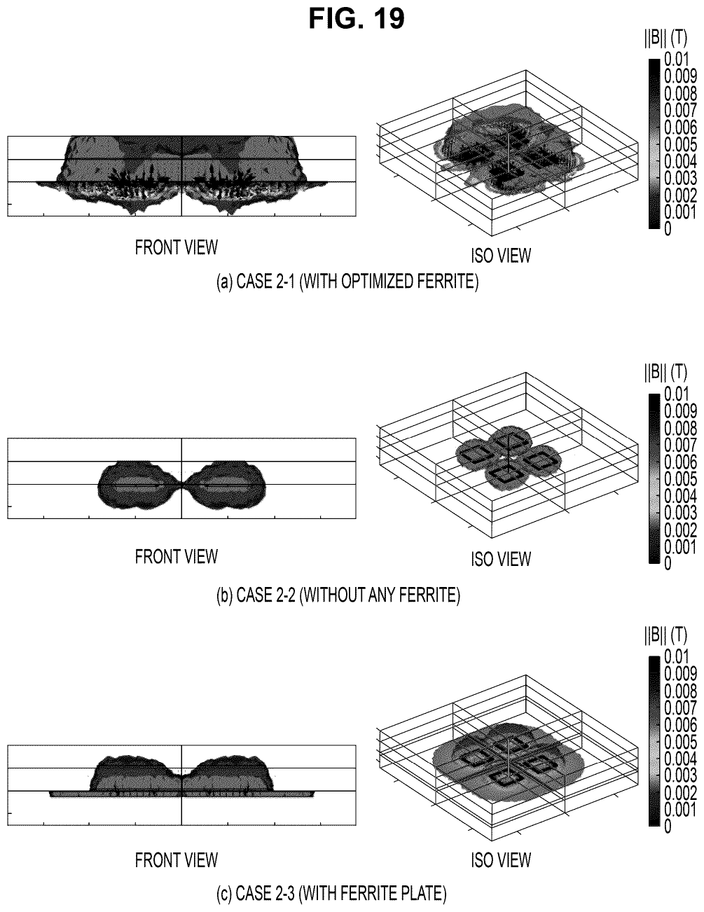

FIGS. 15, 16A, 16B, 16C, and 16D are diagrams for describing a topology optimization design that is performed on a case in which the transmitter has four transmitter coils (Case 2) according to the first method (Case 2-1). FIG. 17 is a diagram illustrating the results of the topology optimization design for ferrite, which is performed on a case in which the transmitter has four transmitter coils (Case 2) according to the first method (Case 2-1). FIG. 18 is a diagram illustrating the results of the topology optimization design for the receiver coil, which is performed on the case in which the transmitter includes two transmitter coils (Case 2) according to the three methods (Case 2-1, Case 2-2, and Case 2-3). FIG. 19 is a diagram illustrating the results (i.e., a distribution of magnetic fields) of the analysis of the plurality of finite elements according to the three methods (Case 2-1, Case 2-2, and Case 2-3).

In the first method (Case 2-1), as illustrated in FIG. 15, the transmitter includes four transmitter coils, and a reception area and a transmission area are defined. According to the first method, in the reception area and the transmission area, the structure of the receiver coil and the structure of the ferrite are optimized. Specifically, as illustrated in FIG. 16A, according to optimization iteration, the structure of the receiver coil is gradually optimized in the reception area. As illustrated in FIG. 16B, according to the optimization iteration, the structure of the ferrite is gradually optimized in the transmission area. In this case, as illustrated in FIG. 16C, according to the optimization iteration, the target function is maximized. As illustrated in FIG. 16D, according to the optimization iteration, all of the restriction conditions have converged less than 0. This means that the restriction conditions are satisfied.

As a result, as illustrated in FIG. 17, the structure of the ferrite is obtained. In a plane that is horizontal to the cross sectional area of the transmitter coil, at least one air layer that hinders leakage flux in a radiation direction thereof is present. In order to increase a coupling coefficient between the transmitter coil and the receiver coil, the ferrite is implemented to surround the at least one air layer. In this case, the ferrite includes an inner part within the cross sectional area of the transmitter coil in the plane and an outskirt part that surround the air layer in the plane. The inner part is connected to the outskirt part.

Furthermore, in the second method (Case 2-2), although not illustrated, the transmitter has four transmitter coils, and a reception area and a transmission area are defined. In this case, the entire transmission area is fixed to the air, and the transmitter coil of the receiver is optimized. In the third method (Case 2-3), although not illustrated, the transmitter has four transmitter coils, and a reception area and a transmission area are defined. In this case, the either transmission area is fixed to the ferrite plate, and the receiver coil of the receiver is optimized.

As illustrated in FIG. 18, the results of topology optimization designs for the receiver coil, which are performed according to the three methods (Case 2-1, Case 2-2, and Case 2-3), are changed according to optimization iteration. According to the first method (Case 2-1), the final structure of the receiver coil has two separated coils, and each of the two coils has an 8-shaped form. According to the second and third methods (Case 2-2 and Case 2-3), the final structure of the receiver coil has four separated coils, and each of the four coils has an elliptical shape. In order to satisfy the target voltage, the numbers of turns of the receiver coil in the first, second, and third methods (Case 2-1, Case 2-2, and Case 2-3) are 8.50 turns, 21.2 turns, and 10.9 turns, respectively. That is, all of the structures of the receiver coils that are derived according to the three methods (Case 2-1, Case 2-2, and Case 2-3) satisfy the target voltage (e.g., 5 V). In this case, for a fair comparison, the weight of the ferrite is identically set in the first method and the third method (Case 2-1 and Case 2-3). The restriction condition for electric field strength is satisfied, and the results of FIG. 18 are arranged like Table 2.

TABLE 2

| | First method | | | | Third method | |
|---|---|---|---|---|---|---|
| | (Case 2-1; | | Second method | | (Case 2-3; | |
| | including optimized | | (Case 2-2; | | including ferrite | |
| | ferrite) | | no ferrite) | | plate) | |
| Target | 5.00 V | | | | | |
| voltage | | | | | | |
| Available | 125 g | | | | | |
| ferrite | | | | | | |
| weight | | | | | | |
| Reference | 5.00 A/m | | | | | |
| electric field | | | | | | |
| strength | | | | | | |
| Derived | 5.00 | V | 5.00 | V | 5.00 | V |
| voltage | | | | | | |
| Ferrite | 125 | g | 0 | | 125 | g |
| weight | | | | | | |
| Electric | 3.31 | A/m | 1.96 | A/m | 8.12 | A/m |
| field strength | | | | | | |
| Number of | 8.50 | turns/sets | 21.2 | turns/sets | 10.9 | turns/sets |
| turns of the | | | | | | |
| receiver coil | | | | | | |
| Number of | 2 | sets | 4 | sets | 4 | sets |
| receiver coil | | | | | | |
| sets | | | | | | |
| Receiver | 1.35 | g | 3.44 | g | 1.82 | g |
| coil weight | | | | | | |

| | | | |
|---|---|---|---|
| Receiver | −60.8% | 0.00% | −47.1% |
| coil weight | | | |
| ratio | | | |

According to Table 1, the third method can more reduce the weight of the receiver coil by about 47.1% than the second method. The first method can more reduce the weight of the receiver coil by about 60.8% than the second method. The reason why the first method can more reduce the weight of the receiver coil than the third method is that the optimized ferrite has small leakage flux because the optimized ferrite has the air layer that hinders leakage flux, whereas the ferrite plate has great leakage flux because the ferrite plate does not include the air layer that hinders leakage flux. This may be checked through the results (i.e., a distribution of magnetic fields) of the analysis of the plurality of finite elements illustrated in FIG. 19.

According to the present disclosure, a topology optimization design for the structure of a charging component within a wireless charging device can be performed based on an algorithm that is designed in software without depending on a designer's intuition. In particular, a topology optimization design for the structure of a charging component within a wireless charging device can be performed so that weight can be minimized while satisfying a target voltage. This can maximize use efficiency of the wireless charging device. As a result, the present disclosure can significantly reduce time and costs that are necessary for a design, fabrication, and experiments by making unnecessary the fabrication of multiple unit products and repeated experiments for each unit product.

The aforementioned system may be implemented with a hardware component, a software component and/or a combination of a hardware component and a software component. For example, the system and component described in the embodiments may be implemented by using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing or responding to an instruction. The processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary knowledge in the art may understand that the processing device may include a plurality of processing elements and/or a plurality of types of processing elements. For example, the processing device may include a plurality of processors or one processor and one controller. Furthermore, another processing configuration, such as a parallel processor, is also possible.

Software may include a computer program, a code, an instruction or a combination of one or more of them and may configure a processing device so that the processing device operates as desired or may instruct the processing devices independently or collectively. The software and/or the data may be embodied in any type of machine, a component, a physical device, or a computer storage medium or device in order to be interpreted by the processing device or to provide an instruction or data to the processing device. The software may be distributed to computer systems connected over a network and may be stored or executed in a distributed manner. The software and the data may be stored in one or more computer-readable recording media.

The method according to various embodiments may be implemented in the form of a program instruction executable by various computer means, and may be stored in a computer-readable medium. In this case, the medium may continue to store a computer-executable program, or may temporarily store the computer-executable program for execution or download. Furthermore, the medium may be various recording means or storage means having a form in which a single piece of hardware or several pieces of hardware have been combined, and is not limited to a medium that is directly connected to any computer system and may be present by being distributed on a network. Examples of the medium may be magnetic media such as a hard disk, a floppy disk, and a magnetic tape, optical media such as CD-ROM and a DVD, magneto-optical media such as a floptical disk, and may be constructed to store computer instructions, such as, ROM, RAM, and flash memory. Furthermore, examples of another medium may include an app store in which apps are distributed, a site in which other various pieces of software are supplied or distributed, and recording media and/or storage media that are managed in a server.

Various embodiments of this document and the terms used in the embodiments are not intended to limit the technology described in this document to a specific embodiment, but should be construed as including various changes, equivalents and/or alternatives of a corresponding embodiment. In relation to the description of the drawings, similar reference numerals may be used in similar components. An expression of the singular number may include an expression of the plural number unless clearly defined otherwise in the context. In this document, an expression, such as “A or B”, “at least one of A and/or B”, “A, B, or C” or “at least one of A, B and/or C”, may include all of possible combinations of items listed together. Expressions, such as “a first,” “a second,” “the first”, and “the second”, may modify corresponding components regardless of its sequence or importance, and are used to only distinguish one component from another component and do not limit corresponding components. When it is described that one (e.g., a first) component is “(functionally or communicatively) connected to” or “coupled with” the other (e.g., a second) component, one component may be directly connected to another component or may be connected to another component through another component (e.g., a third component).

The term “module” used in the present disclosure includes a unit configured as hardware, software or firmware, and may be interchangeably used with a term, such as logic, a logical block, a part or a circuit. The module may be an integrated part, a minimum unit to perform one or more functions, or a part thereof. For example, the module may be configured as an application-specific integrated circuit (ASIC).

According to various embodiments, each (e.g., a module or a program) of the aforementioned elements may include a single entity or a plurality of entities. According to various embodiments, one or more of the aforementioned components or steps may be omitted or one or more other components or steps may be added. Alternatively or additionally, a plurality of components (e.g., modules or programs) may be integrated into a single component. In such a case, the integrated component may identically or similarly perform a function performed by a corresponding one of the plurality of components before one or more functions of each of the plurality of components are integrated. According to various embodiments, steps performed by a module, a program or another component may be executed sequentially, in parallel, iteratively or heuristically, or one or more of the steps may be executed in different order or may be omitted, or one or more other steps may be added.

The embodiments of the disclosure in which an exclusive property or privilege is claimed are defined as follows:

1. A method of a computer device, which performs a topology optimization design on a wireless charging device, the method comprising:
expressing at least some area in which a charging component is to be disposed in a wireless charging device as a plurality of finite elements;
calculating a derived voltage of the at least some area through an analysis of the plurality of finite elements; and
deriving a topology optimization design for a structure of the charging component within the at least some area by performing optimization based on the derived voltage.

2. The method of claim 1, wherein:
the wireless charging device comprises a receiver and a transmitter, and the expression of the at least some area as the plurality of finite elements comprises:
dividing at least some area of the receiver into first finite elements and dividing at least some area of the transmitter into a plurality of second finite elements; and
assigning a first design variable that is defined to express multiple material states to each of the plurality of first finite elements and assigning a second design variable that is defined to express multiple material states to each of the plurality of second finite elements.

3. The method of claim 2, wherein the calculating of the derived voltage comprises:
expressing reluctivity of each of the plurality of second finite elements by using the second design variable;
expressing electromagnetic properties of each of the plurality of second finite elements by using the second design variable and the reluctivity; and
calculating the derived voltage that is expressed as the first design variable and the second design variable with respect to each of the plurality of first finite elements by performing the analysis of the plurality of finite elements on the electromagnetic properties.

4. The method of claim 3, wherein the deriving of the topology optimization design comprises:
constructing an optimization target function and restriction conditions; and
deriving the topology optimization design that satisfies the target function and the restriction conditions, wherein the target function is set as a maximization of the derived voltage, and the restriction conditions are set as at least one of a condition in which a weight of the charging component is a preset weight or less or a condition in which magnetic intensity measured at an arbitrary point is a preset value or less in order to satisfy International Standards for Human Hazard.

5. The method of claim 1, wherein:
the wireless charging device comprises a receiver having at least one receiver coil and a transmitter having at least one transmitter coil and at least one piece of ferrite, and
the charging component comprises at least one of the receiver coil or the ferrite.

6. The method of claim 5, further comprising determining a number of turns of the receiver coil that satisfies a predetermined target voltage within the structure of the charging component if the charging component comprises the receiver coil.

7. The method of claim 5, wherein:
at least one air layer that hinders leakage flux in a radiation direction of the at least one transmitter coil of the transmitter is present, the ferrite comprises an inner part within a cross sectional area surrounded by the transmitter coil and an outskirt part that surrounds the air layer, and the inner part and the outskirt part are connected.

8. The method of claim 2, wherein:
the material states are for a material of the charging component and air, and the design variable is for indicating a relative density of the material of the charging component.

9. The method of claim 1, wherein the structure of the charging component comprises at least one of a number of the charging component or a shape, dimension, or location of the charging component.

10. A computer device which performs a topology optimization design on a wireless charging device, the computer device comprising:
memory; and
a processor connected to the memory and configured to execute at least one instruction that is stored in the memory,
the processor is configured to
express at least some area in which a charging component is to be disposed in a wireless charging device as a plurality of finite elements,
calculate a derived voltage of the at least some area through an analysis of the plurality of finite elements, and
derive a topology optimization design for a structure of the charging component within the at least some area by performing optimization based on the derived voltage.

11. The computer device of claim 10, wherein:
the wireless charging device comprises a receiver and a transmitter, and
the processor is configured to
divide at least some area of the receiver into first finite elements and divide at least some area of the transmitter into a plurality of second finite elements; and
assign a first design variable that is defined to express multiple material states to each of the plurality of first finite elements and assign a second design variable that is defined to express multiple material states to each of the plurality of second finite elements.

12. The computer device of claim 11, wherein the processor is configured to
express reluctivity of each of the plurality of second finite elements by using the second design variable,
express electromagnetic properties of each of the plurality of second finite elements by using the second design variable and the reluctivity, and
calculate the derived voltage that is expressed as the first design variable and the second design variable with respect to each of the plurality of first finite elements by performing the analysis of the plurality of finite elements on the electromagnetic properties.

13. The computer device of claim 12, wherein the processor is configured to
construct an optimization target function and restriction conditions, and
derive the topology optimization design that satisfies the optimization target function and the restriction conditions,
wherein the target function is set as a maximization of the derived voltage, and
the restriction conditions are set as at least one of a condition in which a weight of the charging component is a preset weight or less or a condition in which magnetic intensity measured at an arbitrary point is a preset value or less in order to satisfy International Standards for Human Hazard.

14. The computer device of claim 10, wherein:
the wireless charging device comprises a receiver having at least one receiver coil and a transmitter having at least one transmitter coil and at least one piece of ferrite, and
the charging component comprises at least one of the receiver coil or the ferrite.

15. The computer device of claim 14, wherein if the charging component comprises the receiver coil and the charging component is at least one receiver coil, the processor is configured to determine a number of turns of the receiver coil that satisfies a predetermined target voltage within the structure of the charging component.

16. The computer device of claim 14, wherein:
at least one air layer that hinders leakage flux in a radiation direction of the at least one transmitter coil of the transmitter is present,
the ferrite comprises an inner part within a cross sectional area surrounded by the transmitter coil and an outskirt part that surrounds the air layer, and
the inner part and the outskirt part are connected.

17. The computer device of claim 11, wherein:
the material states are for a material of the charging component and air, and
the design variable is for indicating a relative density of the material of the charging component.

18. The computer device of claim 10, wherein the structure of the charging component comprises at least one of a number of the charging component or a shape, dimension, or location of the charging component.

19. A non-transitory computer-readable recording medium in which a computer program for executing a method of performing a topology optimization design on a wireless charging device in a computer device, the method comprising:
expressing at least some area in which a charging component is to be disposed in a wireless charging device as a plurality of finite elements;
calculating a derived voltage of the at least some area through an analysis of the plurality of finite elements; and
deriving a topology optimization design for a structure of the charging component within the at least some area by performing optimization based on the derived voltage.

20. The non-transitory computer-readable recording medium of claim 19, wherein if the charging component comprises at least one receiver coil of a receiver, the method further comprises determining a number of turns of the receiver coil that satisfies a predetermined target voltage within the structure of the charging component.
